(19) United States
(12) Patent Application Publication
(10) Pub. No.: US 2010/0303188 A1
(43) Pub. Date: Dec. 2, 2010

(54) Interactions of Charged Particles on Surfaces for Fusion and Other Applications

(75) Inventor: Nabil M. Lawandy, Saunderstown, RI (US)

Correspondence Address: K&L Gates LLP, STATE STREET FINANCIAL CENTER, One Lincoln Street, BOSTON, MA, 02111-2950, US

(73) Assignee: Nabil M. Lawandy, Saunderstown, RI (US)

(21) Appl. No.: 12/555,367

(22) Filed: Sep. 8, 2009

Related U.S. Application Data
(60) Provisional application No. 61/182,936, filed on Jun. 1, 2009.

(51) Int. Cl. G21B 1/00; G21B 3/00

(52) U.S. Cl. 376/107; 976/DIG. 4

(57) ABSTRACT

A method of generating a chemical and nuclear reactions includes providing a surface formed between a first medium and a second medium, the first medium having a first dielectric constant, ∈, and the second medium having a second dielectric constant, ∈_{S}, wherein ∈ and ∈_{S} satisfy the relationship

$$\frac{( ɛ - {ɛ}_{S} )}{( ɛ + {ɛ}_{S} )} < - \frac{1}{2} ;$$

depositing a plurality of like-charged parties, e.g., ions or nuclei capable of fusion, in the first medium adjacent to the surface; and wherein a potential binding energy between the plurality of charged particles causes a distance between at least two of the charged particles to be sufficiently small to result in chemical reaction or nuclear fusion of the at least two charged particles.

### CROSS REFERENCE TO RELATED APPLICATIONS

This application claims the benefit of U.S. Provisional Patent Ser. No. 61/182,936 filed Jun. 1, 2009, the entire disclosure of which is incorporated by reference herein.

### FIELD OF INVENTION

The present invention relates generally to the interactions of charged particles on surfaces and their collective many-particle long-range Coulomb interactions, and more specifically to the generation of energy from chemical and nuclear reactions including nuclear fusion at low temperatures.

### BACKGROUND

Nuclear fusion is a naturally occurring phenomenon in stars, and it is the process responsible for the energy created by our sun. Fusion is the process by which small, low mass nuclei join to form larger nuclei with a final mass lower than the sum of the initial nuclear masses and release energy. Fusion of light nuclei such as hydrogen isotopes was first observed by Oliphant in 1932, and the progression of this process to the cycle of nuclear fusion in stars was later worked out by Hans Bethe.

Attempts to create fusion for military applications began with the Manhattan Project and were successfully demonstrated in 1952. Work has continued since then to harness this process for generating cleaner energy in the form of controlled fusion. This work has met considerable obstacles. Nevertheless, some tokamak-based reactors around the world have demonstrated break-even controlled fusion reactor designs that are expected to eventually deliver as much as ten times the energy needed to heat plasma to the required temperatures for fusion to occur. One such reactor, originally known as the International Thermonuclear Experimental Reactor (known now simply as “ITER”), is expected to be operational in 2016.

The enormous energy required to drive nuclear reactions is a consequence of the combination of the extremely short range of the attractive strong force and the repulsion between like charges. The energy required to overcome the repulsive forces between light nuclei at the required distances for fusion to occur is on the order of about 10,000 electron volts (eV) to about 1,000,000 eV. Once these conditions are achieved, an exothermic reaction, which releases several mega-electron volts (MeV) of energy, new nuclei and neutrons, can result in a self-sustaining reaction. For example, the deuterium-tritium (D-T) reaction releases about 17 MeV in the recoil energy of the resultant helium (He) nucleus and the released neutron. Similarly, deuterium-deuterium (D-D) reactions exhibit two equally probable channels of fusion with energy release of about 4 MeV and about 3.7 MeV.

Most processes for producing fusion reactions of light nuclei fall into three major classifications: Hot Fusion, Generally Cold-Locally Hot Fusion, and Locally Cold Fusion. Hot Fusion is based on reaching temperatures in the millions of Kelvin and confining the hot plasma to achieve a significant reaction rate consistent with the well-known Lawson Criterion. Methods such as Magnetic Confinement and Inertial Confinement have been developed to drive such processes. The second class of processes relies on the generation of locally hot regions of space where plasma is in contact with a generally cold environment. In other words, the actual region of interest achieves high temperatures or energies while in contact with matter at low temperatures. Various attempts to observe fusion reactions in such systems have been tested and include accelerator-based systems, the Farnsworth-Hirsch Fusor, Antimatter-initialized Fusion, Pyroelectric Fusion and Sonoluminescence.

Over thirty years ago, Locally Cold Fusion experiments were carried out using muons to catalyze the fusion process at ordinary temperatures. In this process, muons, which are negatively charged particles, are injected into molecular gases with light nuclei such as deuterium, and the electrons binding the nuclei are replaced through a collisional mechanism with negatively charged muons, which have a mass much larger than that of the electron. The heavier mass results in bond lengths that are over two hundred times shorter than the Bohr radii characteristic of bond lengths due to the lighter electrons, allowing the nuclei to be close enough to experience the Strong Force and to fuse to produce heavier nuclei with the release of energy. Unfortunately, the muon catalyzed fusion suffers from the short 2.2 microsecond lifetime of the muons and the so-called alpha sticking problem, where the muon will bind to the created alpha particles and stop catalyzing the reaction.

Twenty years ago, Cold Fusion was reported using electrolysis of heavy water with palladium electrodes. Anomalous excess heat generation and traces of Tritium and Helium in the deuterated electrolyte were also reported. Unfortunately, for two decades, no consistent set of experiments has emerged, and several theoretical works have shown that the effects of palladium and other metals with similar electronic configurations on the internuclear separation of deuterium nuclei within the metal were insignificant and incapable of producing the measured energy release observed in some experiments.

### SUMMARY

Embodiments of the invention include a system and method of energy generation by the fusion of nuclei at temperatures below 10,000K. The generation of energy is achieved by fusion reactions, which result from depositing or creating charged nuclei on a surface or an interface between a high dielectric constant material, such as a metal or dielectric, and a lower dielectric constant relative to the medium in which the charged nuclei reside. An attractive potential is created between two or more positively (or negatively) charged particles on the surface of the material with the significantly larger dielectric constant. This attractive potential has its origin in the electrostatic solutions to Laplace's equation for a charge in front of a dielectric or metal plane or other shapes with curvature and edges. The attractive potential is equally expected for negatively charged particles such as ions, electrons and muons, and can result in binding of such particles in the same way as described for nuclei. In the case of electrons, other effects such as enhanced transport, new bound states between similarly and differently charged particles, and superconductivity may be achievable.

Forty years ago it was predicted that electrons could be trapped above metallic and dielectric surfaces by image forces. Single electrons would be expected to exhibit an infinite number of bound image states, which exhibit a Rydberg series similar to hydrogenic atoms. This work successfully explained the experimentally observed trapping of electrons above the surface of liquid helium. Since this pioneering work, many such systems have been identified and studied extensively using a variety of realistic crystal potentials and various particle scattering and optical techniques. In addition to planar surfaces, work on clusters, droplets, and carbon nanotubes has also been undertaken.

In general, in one aspect, the invention features a method of generating a reaction including providing a surface or interface formed between a first medium and a second medium, the first medium having a first dielectric constant, ∈, and the second medium having a second dielectric constant, ∈_{S}, wherein ∈ and ∈_{S} satisfy the relationship:

$$\frac{( ɛ - {ɛ}_{S} )}{( ɛ + {ɛ}_{S} )} < - \frac{1}{2} ;$$

depositing a plurality of like-charged particles in the first medium adjacent to the surface; and wherein a potential binding energy between the plurality of like-charged particles causes a distance between at least two of the like-charged particles to be sufficiently small to result in reaction of the at least two like-charged particles. The reaction can be nuclear fusion for nuclei particles and chemical or catalytic for ion particles.

In general, in another aspect, the invention features a method of generating a fusion reaction including providing a surface or interface formed between a first medium and a second medium, the first medium having a first dielectric constant, ∈, and the second medium having a second dielectric constant, ∈_{S}, wherein ∈ and ∈_{S} satisfy the relationship:

$$\frac{( ɛ - {ɛ}_{S} )}{( ɛ + {ɛ}_{S} )} < - \frac{1}{2} ;$$

depositing a plurality of ions with nuclei capable of fusion in the first medium adjacent to the surface; and wherein a potential binding energy between the plurality of ions causes a distance between at least two of the ions to be sufficiently small to result in fusion of the at least two ions. In embodiments, the ions may be atomic ions or molecular ions. The plurality of ions may contain nuclei selected from the group consisting of H, D, T, Li and He.

Embodiments of the invention may include one or more of the following features. Cooperative long-range effects of the plurality of like-charged particles may cause the distance between the at least two like-charged particles to be sufficiently small to result in fusion or catalysis. The method may further include attracting a distant particle to the plurality of like-charged particles with sufficient energy to cause a collision with one of the plurality of like-charged particles and to cause the fusion or catalytic reaction. The method may further include forming the plurality of like-charged particles using radiation, which may be selected from the group consisting of microwave radiation, infrared radiation, visible light, ultraviolet radiation, and X-Ray radiation. The plurality of like-charged particles may be formed from an electrical discharge of atoms or molecules.

The first medium may include a conduit to carry a fluid or gas for recovering useful heat energy generated within the first medium. The second medium may include a conduit to carry fluid for transmitting heat generated within the second medium. The surface may support plasmon-polariton or phonon-polariton resonance due to a phonon or electronic response. The second medium may include SiC. The plurality of like-charged particles may be light nuclei. The light nuclei may be selected from the group consisting of H, D, T, Li, and He.

The surface may include an interior of a pore within a porous medium, the pore including the first medium and the porous medium including the second medium. The porous medium may include a conduit to carry fluid for transmitting heat generated within the porous medium. The porous medium may support plasmon-polariton resonance. The porous medium may be selected from the group consisting of SiC, a zeolite, an inclusion compound, and a clathrate. The porous medium may be substantially transparent to radiation capable of dissociating molecules containing like-charged particles capable of fusion.

The method may further include applying a muon beam to catalyze fusion. The second medium may be a catalyst material with an affinity for electrons. The surface may be the interior of a tube. The surface may be the exterior of a tube. The tube may be a carbon nanotube. The tube may be an inclusion complex, which may include urea. The nanotube may be a multi-walled carbon nanotube.

In general, in another aspect, the invention features a method of generating a reaction including providing an array of surfaces formed by alternating first mediums and second mediums, the first mediums having a first dielectric constant, ∈, and the second mediums having a second dielectric constant, ∈_{S}, wherein ∈ and ∈_{S} satisfy the relationship:

$$\frac{( ɛ - {ɛ}_{S} )}{( ɛ + {ɛ}_{S} )} < - \frac{1}{2} ;$$

depositing a plurality of like-charged particles capable of in the first mediums adjacent to the surfaces; and wherein a potential binding energy between the plurality of like-charged particles causes a distance between at least two of the like-charged particles to be sufficiently small to result in of the at least two like-charged particles. The reaction can be nuclear fusion for nuclei particles and chemical or catalytic for ion particles. In embodiments, the array of surfaces may be formed by an intercalated compound selected from the group consisting of cuprates, graphite and grapheme. The method may further include applying an electric field between the array surface layers to remove negative electrons after ionization or to produce static field ionization. The method may further include applying a muon beam to catalyze fusion. The array of surfaces may be radiated with light to dissociate and ionize the plurality of like-charged particles, and the light may have a dissociation and ionization wavelength in the infrared range from 2-15 microns. The radiated light may be produced using a CO₂ or N₂O laser, and may include photons with energies in the range from 20 eV to 1 eV. Mechanisms of dissociation and ionization include single-photon, multi-photon, and Keldysh processes.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1. is a diagram if the interaction between two like charges at an interface between two media in accordance with an embodiment of the invention;

FIG. 2 is a graph depicting the attractive potential between two charges in accordance with an embodiment of the invention;

FIG. 3 is a graph depicting the position of minimum separation between like charges in a 1-D chain in accordance with an embodiment of the invention;

FIG. 4 is a graph depicting the behavior of like charges in a 1-D chain in accordance with an embodiment of the invention;

FIG. 5 is a graph depicting the length of a 1-D chain as a function of the number of charges in accordance with an embodiment of the invention;

FIG. 6 is a logarithmic graph depicting the minimum separation between like charges in a 1-D chain in accordance with an embodiment of the invention;

FIG. 7 is a graph depicting the minimum separation of like charges as a function of the number of charges in a 1-D chain with a parallel plate arrangement in accordance with an embodiment of the invention;

FIG. 8 is a graph depicting the minimum pair trajectory separation of like charges as a function of the number of charges in accordance with an embodiment of the invention;

FIG. 9 is a table depicting some of the geometric distributions of like charges on a surface with image forces binding the charges together in accordance with an embodiment of the invention;

FIGS. 10(a)-(f) depict some of the geometric shapes of like charges on a surface in accordance with an embodiment of the invention;

FIG. 11 is a graph depicting the minimum separation of like charges in a 2-D structure as a function of the number of particles in accordance with an embodiment of the invention;

FIG. 12 is a graph depicting the positions of minimum separation between two hexagonal shells in accordance with an embodiment of the invention;

FIG. 13 is a graph depicting the maximum dimension of a hexagonal symmetry distribution as a function of the number of particles in accordance with an embodiment of the invention;

FIG. 14 is a logarithmic graph depicting the minimum spacing between like charges in a 2-D hexagonal arrangement in accordance with an embodiment of the invention;

FIGS. 15(a)-(d) depict multiple surface implementations in accordance with an embodiment of the invention;

FIG. 16 depicts a single walled carbon nanotube in accordance with an embodiment of the invention; and

FIGS. 17(a)-(b) depicts a muon bean used to catalyze fusion in accordance with an embodiment of the invention.

### DETAILED DESCRIPTION

The invention will be more completely understood through the following detailed description, which should be read in conjunction with the attached drawings. Detailed embodiments of the invention are disclosed herein; however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

The development of methods and processes for the realization of fusion at conventional temperatures requires that two repulsive charges are brought together through some means to allow the Strong Force to overcome the Coulomb repulsion, resulting in a fusion event and the release of energy. In muon catalyzed fusion, this may be accomplished by transforming the binding energy of nuclei in molecules through the substitution of a negatively charged and much heavier muon for the electron. In essence, the chemical energy stored in the system or the bond strength is transformed to match the otherwise much larger nuclear repulsive energies that occur on nuclear length scales.

In an attempt to exploit the properties of electrons above liquid helium, a body of work has emerged on multi-electron systems confined to the surface of liquid helium for quantum computing applications. This work has focused on the weakly interacting limit that allows for the creation of qubit states by switching voltages on separated electrodes. For quantum computing applications, electrons at typical surface densities of 10⁸ cm⁻² or less behave classically and are trapped within the potential of each electrode with only weak repulsive interactions between them. This weak interaction remains purely repulsive as the dielectric constant of liquid helium is extremely low (∈=1.0568).

When the dielectric constant is much higher, the interaction of each real charge with the other charge's image can result in a sizable long range attractive component. This attractive force is simply the result of satisfying the boundary conditions for the Poisson equation with two charges above a plane and is a result of the superposition of the resulting surface charge densities at the interface.

According to one embodiment of the present invention, an attractive potential between two or more similarly charged particles or ions, including those containing fusable nuclei, on the surface of a material with a significantly large dielectric constant relative to the medium in which the charged particles reside is created. According to various embodiments of the invention, the surface may be silicon carbide (SiC), graphite, graphene, a metal, a dielectric, a zeolite, or an inclusion compound, adduct or clathrate. This attractive potential has its origin in the electrostatic solutions to Laplace's equation for a charge in front of a dielectric or metal plane or other shape. Lord Kelvin showed that the fields outside the metal or dielectric material due to the accumulation of surface charge (in the case of a perfect conductor) could be fully described by placing one or more fictitious image charges within the dielectric or metal at appropriate distances and with appropriate charges relative to the real charge.

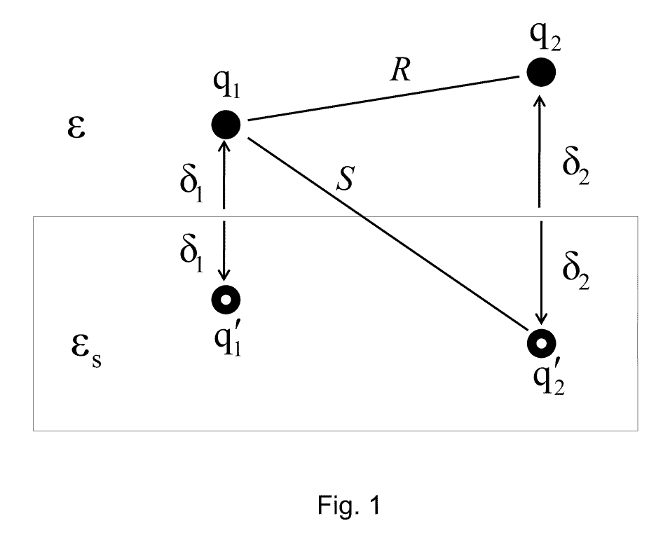

As shown in FIG. 1, when two charges are disposed above a substrate, the potential energy between the charges is due to a combination of the actual charges repelling each other and the attractive interaction of the charges interacting with their own image charge as well as the other charge's image. Since the particle's own image charge moves with it, this portion of the potential is an additive constant independent of the separation between the charges.

When two like charges, whether they are electrons, positrons, ions, muons, or deuterium nuclei are bound by image charges to a surface, as shown in FIG. 1, the energy governing their relative interaction is given by (δ₁=δ₂=δ):

$$U = \frac{( {Z}_{1} e ) ( {Z}_{2} e )}{4 πɛ} ( \frac{1}{R} + \frac{2 β}{S} ) \qquad ( 1 )$$

Where q₁=Z₁e and q₂=Z₂e are the real charges, ∈ and ∈_{S} are the permittivities of the space the charges reside in and the substrate respectively, and

$$β = \frac{[ ɛ - {ɛ}_{S} ]}{[ ɛ + {ɛ}_{S} ]} .$$

In the limit that both charges are at the same height δ, above the ideal interface, the potential exhibits a local minimum at a charge separation given by:

$${R}_{min}^{2} = \frac{4 {δ}^{2}}{{( 2 β )}^{\frac{2}{3}} - 1} \qquad ( 2 )$$

Equation (2), as well as the minimization of the force equation shows that when β

$$< - \frac{1}{2} ,$$

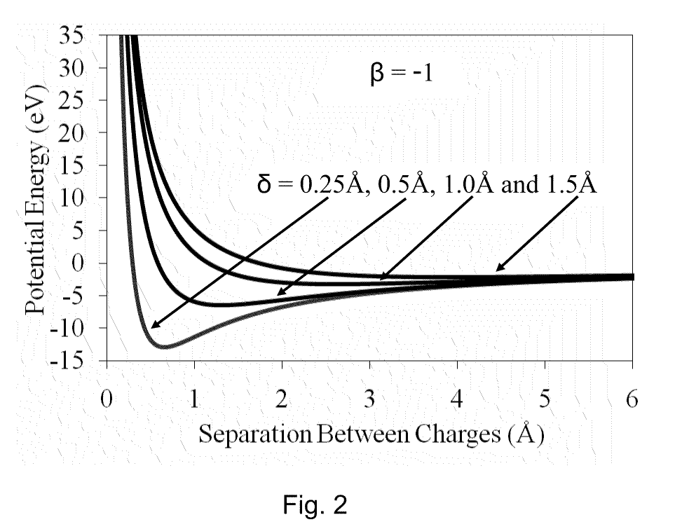

there will be a bound state. Clearly, for experiments with liquid helium, this was not the case since for that system, β=−0.027. Using materials with a negative dielectric constant can lead to β<<−1. FIG. 2 illustrates the potential energy as a function of the separation between deuterium nuclei for various values of δ and β=−1

For two like charges of magnitude Z₁e and Z₂e, respectively, residing in free space (∈=∈₀) above a high dielectric constant substrate the binding energy in electron volts between the two positively or negatively charged particles is given by:

$$U ( e V ) = - {\frac{7.2 ( {Z}_{1} {Z}_{2} )}{δ} [ {( 2 β )}^{\frac{2}{3}} - 1 ]}^{\frac{3}{2}} \qquad ( 3 )$$

where δ is given in angstroms. When δ=1 Å, the pair interaction energy is half of the classical binding energy of a single electron above an ideal classical surface with an infinite dielectric constant difference (β=−1 limit). The potential between two like charges results in a bound two-dimensional state on a high dielectric constant surface with several degrees of freedom including rotation in the plane, rocking on the surface, and vibration with angular frequency of ω˜10¹⁵ s⁻¹ for electrons and ω˜10¹³ s⁻¹ for more massive particles such as D nuclei. The accurate description of these degrees of freedom will depend on the band structure of the solid surface and the resultant effective masses. Including the zero point vibrational energy of the two electrons (˜0.53 eV) results in a ground state binding energy which is approximately three times the ground state energy for an electron trapped above the surface in an ideal image state. For electrons, this two particle bound state can be short-lived due to the lifetime of the surface states, particularly the n=0 states, which penetrate into the bulk. Electrons' lifetimes, however, are particularly short relative to other particles such as more massive and positively charged nuclei and ions.

The pair of bound like charges is analogous to Cooper pairs and will have a ground singlet state of zero spin, thus creating a bosonic quasi-particle for a large number of like charge systems including electrons, muons, nuclei, and ions. The accurate binding energy of pairs of identical particles will include exchange interactions which may become large when the separations are small. Bound states, however, need not be between like particles and can result in new forms of two-dimensional ions such as electrons bound to negative muons where exchange forces are not in effect. It should also be noted that for two oppositely charged particles, the potential is attractive at short separations, but can exhibit a potential barrier at larger separations preventing oppositely charged particles from forming bound states such as hydrogen on the surface except through tunneling or thermal effects. This barrier has a height equal to the relative interaction binding energy for the like charge case but of opposite sign.

Equation (2) shows that the classical equilibrium separation scales as the distance from the surface. Typically, δ is of the order of a few angstroms depending on the details of the band structure of the substrate, the properties of the external charge, and where the vacuum level lies in relation to the various electronic bands. This sets the bound-pair inter-particle equilibrium separation at a distance of about 2.61δ in the β=−1 limit.

For a classical interface, the solution for the most probable distance above the surface obtained from the Schrödinger equation for the wave functions of the image problem are, like the Bohr radius, determined by the mass of the particle, its charge, and the value of β. When the charged particle is a deuteron nucleus above a metallic or high dielectric constant surface, Rₘᵢₙ assumes a value of 10⁻¹³ m, a distance scale where the combination of tunneling and nuclear forces begins to play a significant role. However, this is not the case, as the surface band structure and the extent of electron orbitals limit how small the most likely distance the hydrogenic wavefunction predicts for much more massive particles.

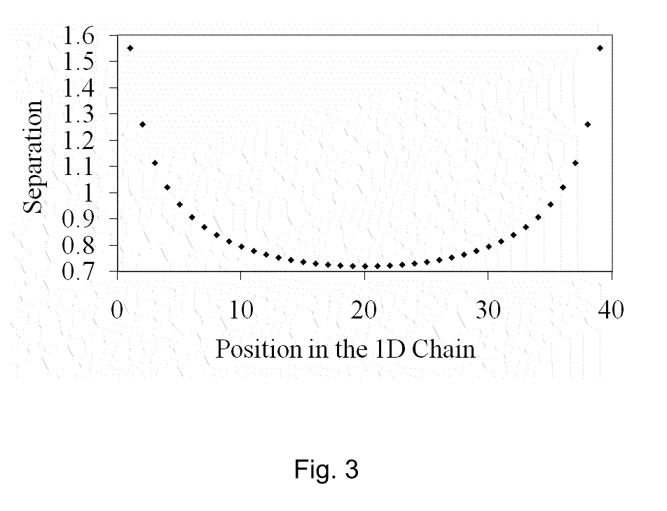

Since the image interactions substituting for the surface charge density at the interface result in long range Coulomb forces, a large ensemble of charges confined to the surface will exhibit collective effects beyond nearest neighbor interactions. For the case of a one dimensional system of charges, simulations reveal that the separation of the like charges exhibits a minimum at the center, as shown in FIG. 3. According to embodiments of the invention, simulations have been carried out for 1-D and 2-D collections of deuterium nuclei on a surface with β=−1. In the case of a 1-D system, the separation of the two center nuclei in a chain shows that there is a compressive force due to the long range nature of the Coulomb interaction with the ensemble of oppositely charged images within the substrate, which mathematically mimic the surface charge distributions required to satisfy Laplace's equation and the electrostatic boundary conditions. FIG. 3 shows the separation in units β of adjacent pairs for a chain of nuclei of length N=40.

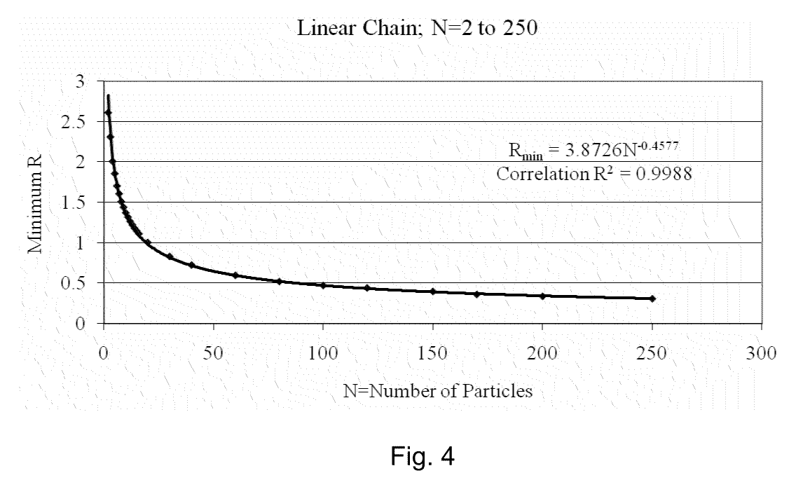

According to one embodiment, a simulation of the 1-D chain shows that the minimum separation between the two center nuclei decreases with increasing N. FIG. 4 shows this behavior when N is between N=2 and N=250.

With increasing numbers of charges in a straight line configuration, a curve fit with 0.999 correlation to the simulation data reveals a scaling law given by:

Rₘᵢₙ₌₍3.8726)δN^{(-0.457)} (4)

where N is the number of particles in the one dimensional chain of charges on the surface with β=−1.

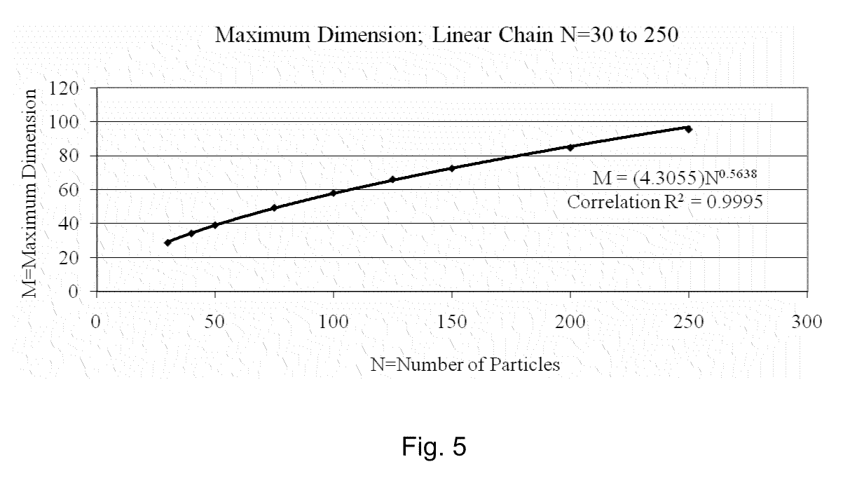

Since the 1-D chain results in a self contraction, the chain length as a function of the number of nuclei exhibits a sub-linear relationship with increasing number of nuclei, N. This is shown in FIG. 5 for N ranging from 30-250. The numerical simulation shows that the chain length scales as

L(N)=(4.305)δN^{(0.5638)} (5)

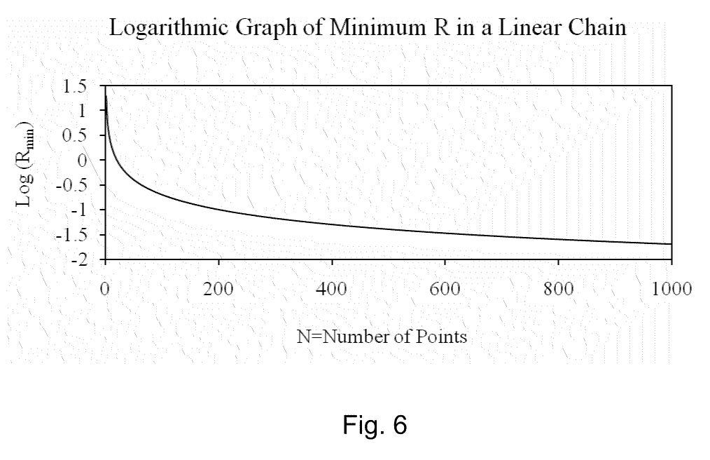

The chain length contraction is consistent with the minimum separation of the closest nuclei also shrinking as a function of increasing N. FIG. 6 shows the extrapolation of the power law to large N to infer that distances of the order of less than 1% of δ are expected for N approaching 10⁶. The results further predict that with N˜10⁹, the charges at the center of the chain are separated by a distance of 10 Fermi when δ=1 Å.

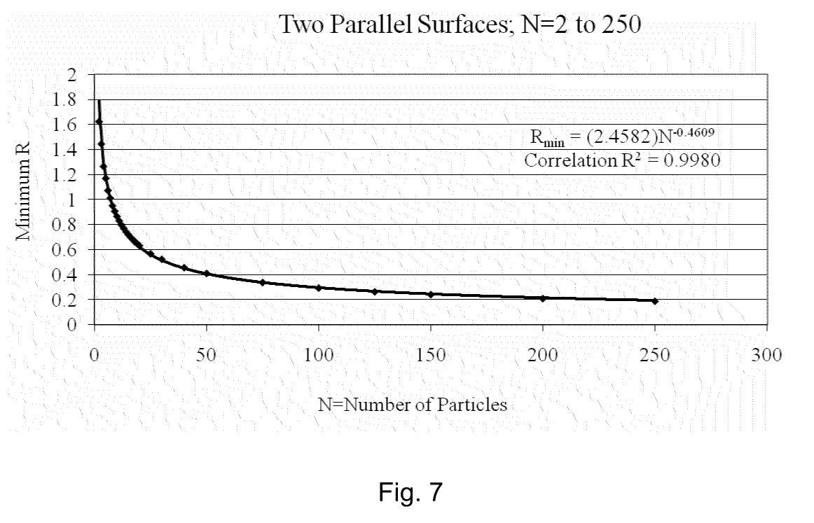

Such 1-D configurations are achieved within confining structures such as adducts of urea, zeolites, intercalation compounds, layered cuprate and other high T_{C} systems and single and multi-walled carbon nanotubes. The use of such structures to confine nucleons and their precursor molecules will result in a modified image potential due to the presence of other boundaries. In the case of a planar system with two infinite surfaces separated by a distance 2d, the bare charges interact with an infinite number of images associated with each real nucleon charge. This parallel plate geometry is an approximation to the layered materials. In this case the interaction is stronger and results in shorter separations as a function of the number of nucleons, N. This behavior is shown in the numerical simulations for the two-surface case shown in FIG. 7. The results of this simulation can be compared to the scaling law found for the minimum distance in the single surface case, and shows that the exponent is slightly larger while the pre-factor is approximately two thirds of the single surface case.

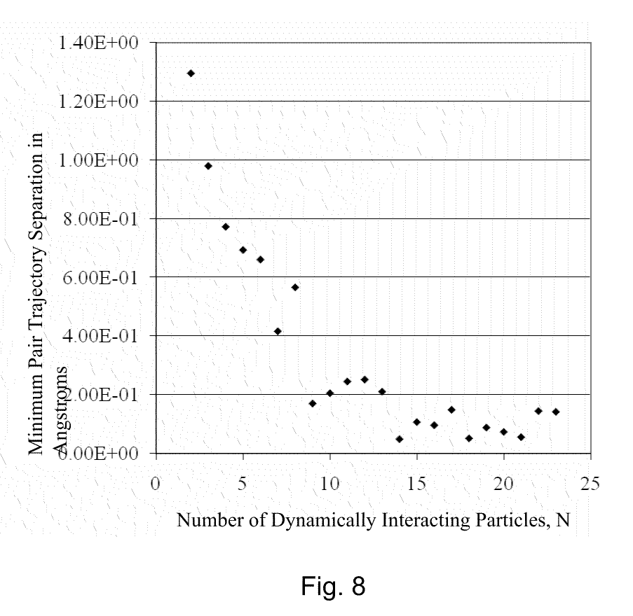

According to another embodiment, a more easily achievable experimental arrangement of nuclei is a 2-D distribution on a smooth surface. This surface has a local smoothness on the scale of δ in order to allow the free rearrangement of charged nuclei on the surface. Numerical simulations with fully interacting pair potentials show that the potential described can result in stable arrangements as well as dynamic trajectories with separations, which are within the range necessary for efficient nuclear fusion to occur. In the limit of no damping, random initial positions and zero initial velocities, simulations of positively charged deuterium nuclei on a surface with β=−1 show that dynamic trajectories occur, which result in closer separations with increasing N. This is expected since the greater the number of particles, the more likely that the potential energy of a cluster can be transferred to a single nucleus. The results of this simulation for increasing N are shown in FIG. 8.

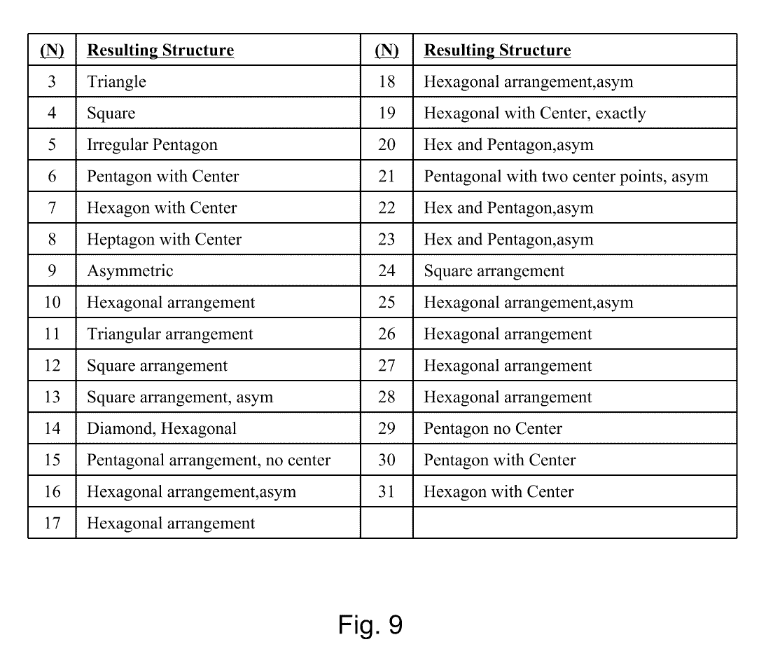

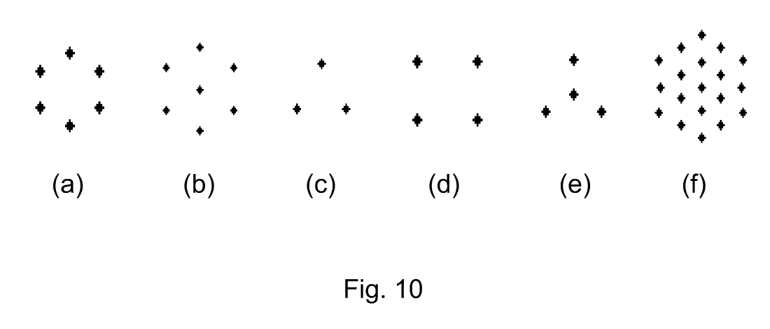

On metallic or dielectric surfaces with ohmic and phonon damping, there will be damping, and the initially random arrangement of charges will dynamically evolve to reach an equilibrium distribution on the surface. Simulations of this process for various numbers of randomly distributed deuterium nuclei on a surface with β=−1 reveal that high symmetry structures evolve. For small number of nuclei, the table of FIG. 9 shows the final distributions of like nuclei on a surface with the image forces binding them together. FIGS. 10(a)-(f) show some of the equilibrium shapes formed as listed in the table of FIG. 8.

On the surface, charges are free to move in two dimensions above the interface and dissipation results in various equilibrium symmetry configurations. When the number of charges is large, close packing dominates and hexagonal symmetry prevails as is often the case in two dimensional systems. Since the attractive component of the two charge potential is of a long range nature, it is expected that interactions far beyond nearest neighbors would play a significant role in determining the surface structure parameters. Simulations which maintain the hexagonal symmetry of the system of particles, but allow for displacements along symmetry vectors show that this two dimensional system of interacting charges results in closest separations between certain particles within neighboring hexagonal shells with much smaller distances than the two particle minimum.

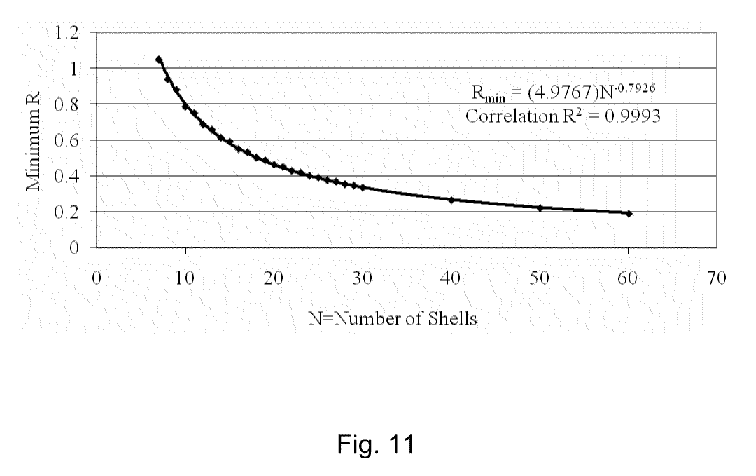

When the number of particles increases, these shapes, as in the 1-D case, contract due to the long range nature of the image interactions, and the separation of the particles decreases to become smaller than the two-particle well minimum distances. Simulations of this effect are shown in FIG. 11 for the commonly occurring case of the hexagonal arrangement with N ranging from N=7 to N=60.

For the case of β=−1, the simulation predicts a scaling law for the minimum separation in the array given by

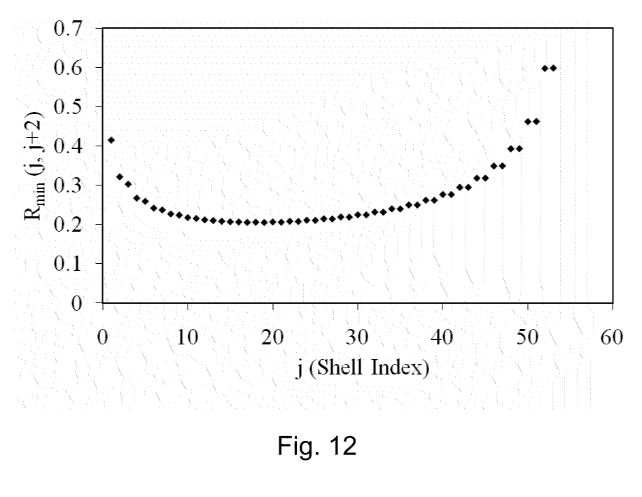

Rₘᵢₙ₌₍4.976)δN^{(-0.7926)} (6)

where N in this case is the number of interacting shells in the hexagonal arrangement. For N=10⁶, and δ=1 Å, Rₘᵢₙ˜10⁻¹⁴ m. FIG. 12 shows the minimum separation as a function of the shell position for the hexagonal arrangement under the forces of the entire ensemble for 330 particles.

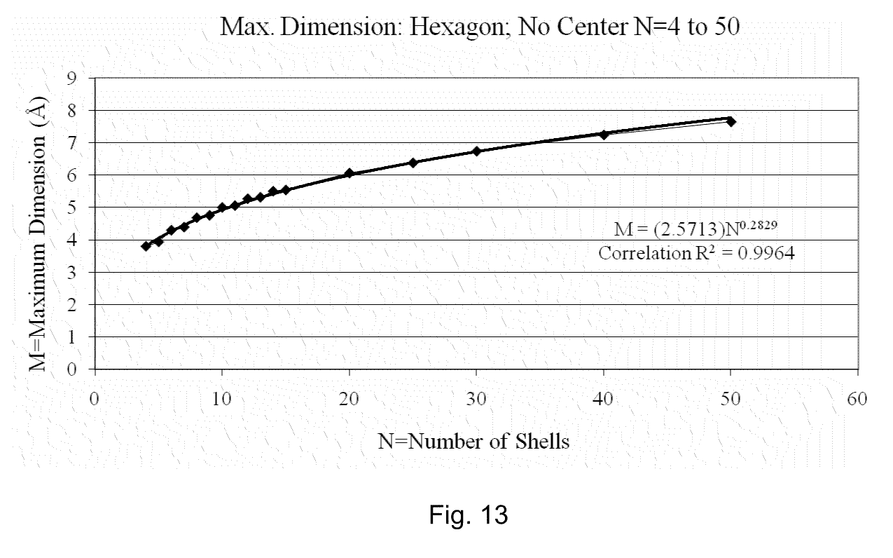

Mirroring this contraction in the minimum distance of particular shells in the hexagonal lattice is an overall contraction of the entire array as described in the 1-D case. FIG. 13 shows the maximum dimension of the hexagonal symmetry distribution as a function of N. The simulation results indicate that the maximum size of the interacting 2-D array of nuclei scales with the number of shells N, as:

L=2.75δN^{(0.2829)} (7)

The scaling of the array size with the number of shells predicts that compaction would result in 10⁶ bare charges such as D or T nuclei occupying an area less than 10⁻¹⁵ m² with a minimum separation of 10 Fermi. In the limit of Rₘᵢₙ<<δ<<L, and large N, the binding energy of a single unit charge to the surface is approximately given by:

$${U}_{b} ( e V ) \sim \frac{e}{8 {πɛ}_{0} δ} {N}^{( 0.44 )} \qquad ( 8 )$$

For the case of N=10⁶, this leads to a value of U_{b}˜3 keV.

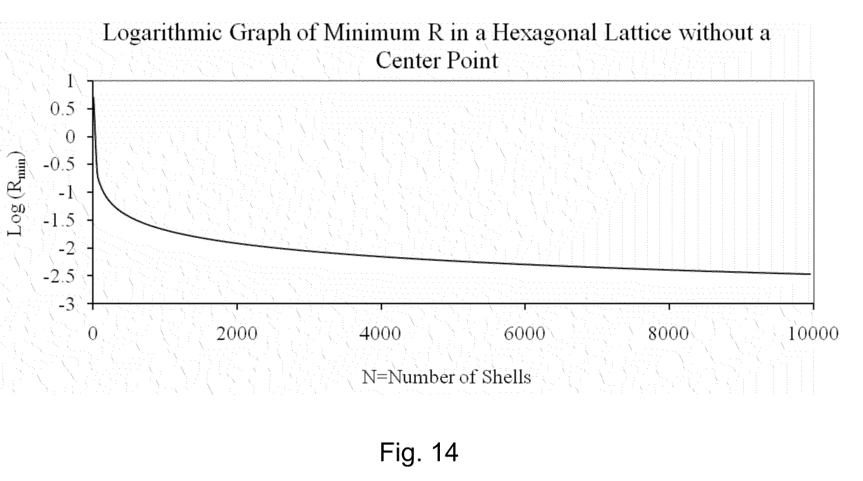

Extrapolating the minimum spacing between nuclei in the 2-D hexagonal steady state arrangement to large numbers of shells results in the graph of FIG. 14, which shows that arrays with the order of 3000 shells lead to separations of the order of 10⁻² δ. For δ values of the order of an Angstrom, the closest separations (Rₘᵢₙ) in hexagonal structures are of the order of 10⁻¹² m or less, well in the range of values to drive significant fusion rates.

The predicted small separations of the charges when N is large, suggests that this system could lead to enhanced fusion rates when an ensemble of charged D, T or D/T mixtures are created on a surface of high dielectric constant, even in the presence of neutrals as forces only act on the charges nuclei. In order to estimate the maximum fusion rate, an estimate of the wavefunction probability of the closest nuclei being separated by distances of the order of the alpha particle diameter (R₀=3.22F) is required. With this estimate, the fusion rate for the specific pair at shells with index j and j+2 respectively is given by:

λ=A|ψ(R₀)|² (9)

where the rate constant A, determined form the low energy limit of the nuclear S-factor for D-D fusion, is given by:

A=1.478×10⁻²² m³s⁻¹ (10)

Much work has been performed on other variants of this problem, beginning with Jackson's calculations for muon catalyzed fusion. Since this work, various calculations using WKB methods to evaluate the fusion rate in systems where fusion might occur at temperatures far below tens of millions of degrees have been undertaken.

In the system described, the ensemble is effectively frozen in place and interacting pairs behave as a one dimensional system capable of vibration and supporting phonons of the entire ensemble of charges forming the structure. In this limit, the system is crudely describable as a nucleon trapped in a potential created by the array whose collective long range interactions have forced the two charges in the j and j+2 shells to a separation where their Coulomb repulsion is preventing further compression. This potential is well estimated by the sum of two terms along the symmetry axis (r) of the pair and is given by:

$${U}_{jj + 2} = \frac{{e}^{2}}{4 {πɛ}_{0}} [ \frac{1}{( r + {R}_{min}} + \frac{1}{( {R}_{min} - r )} ] \qquad ( 11 )$$

This potential has a ground state harmonic oscillator solution with a zero point energy given by:

$${E}_{0} = {h [ \frac{{e}^{2}}{8 {π}^{3} {ɛ}_{0} m {R}_{min}^{3}} ]}^{\frac{1}{2}} \qquad ( 12 )$$

where m is the deuteron mass. At very close separations, this energy is large enough to have an effect on the turning point and the tunneling probability.

In the limit that no condition is placed on the wave function to assume a zero value at r=±Rₘᵢₙ, the Langer correction term is not required, and the Gamow factor (F) for tunneling is approximately given by:

$$F = \frac{2 π}{h} {( {E}_{0} {R}_{min} )}^{\frac{1}{2}} ( E [ {sin}^{- 1} ( \frac{{R}_{0}}{{R}_{min}} ) \vert η ] - E [ {sin}^{- 1} ( \frac{{R}_{1}}{{R}_{min}} ) \vert η ] ) \qquad ( 13 )$$

where E[Φ|η] represents the incomplete elliptic integral of the second kind,

$${η}^{2} = \frac{{e}^{2}}{2 {πɛ}_{0} {E}_{0} {R}_{min}} + 1 ,$$

and R₁ is the turning point for the potential in Equation (12) including zero point vibrational motion in the ground state.

For a nearest neighbor array separation of Rₘᵢₙ=5×10⁻13 m, F=84, a value which is several orders of magnitude smaller than those obtained for Angstrom scale separations of nuclei but much closer to the values in muon catalyzed fusion calculations. The Gamow factor along with an estimated volume for the localization of the deuteron wavefunction of V˜πRₘᵢₙ²δ yields an estimated fusion rate per pair of:

$$λ \approx \frac{A {e}^{- 2 F}}{π {R}_{min}^{2} δ} \qquad ( 14 )$$

At Rₘᵢₙ32 5×10⁻¹³ m, the closest pair fusion rate is λ˜10⁵ s⁻¹.

For an ensemble of 830 charges, Rₘᵢₙ=10⁻¹¹ m, F=37.6, and the highest pair fusion rate expected is ˜10⁻²³ s⁻¹. Increasing the number of particles from 830 to 1000 increases the fusion rate by nineteen orders of magnitude to ˜1.3×10⁻⁴ s⁻¹.

Creating ensembles of charged nuclei on atomically smooth surfaces for a sufficiently long period is not trivial and would require energy input of the order of 1 MeV for ˜35,000 D nuclei. This energy input would in turn release approximately 35 MeV or more when the six closest set of pairs react in approximately 10 μs(λ˜10⁵ s⁻¹). One potentially efficient approach to this problem is the use of infrared driven Keldysh ionization processes which are locally enhanced using phonon-polariton resonances in nano and microcrystalline materials as the substrates. SiC, for example, has a large DC dielectric constant (9.66-10.03, depending on crystalline orientation) and exhibits a strong localized phonon-polariton mode for particles or pores as large as one micron at frequencies resonant with highly efficient pulsed CO₂ lasers. Other experimental approaches include the direct generation of D or T nuclei by static field ionization of monolayers of D₂, DT, T₂ and D₂O as well as discharges of D₂ or D₂O with subsequent separation to expose a high dielectric constant metallic substrate.

According to another embodiment of the invention, a mechanism for producing fusion on 2-D surfaces utilizes the acceleration of a distant nucleus or like charged ion (ionized deuterium, for example) towards an already equilibrated set of nuclei or charged ions. The equilibrated set may be in one of the contracted structures discussed in the table of FIG. 9, and which in most cases is hexagonal for larger numbers of nuclei.

In this case, the distant nucleus is attracted by the combined pair interactions of the nucleus and each of the nuclei in the array. The potential energy of the nucleus increases from zero at infinity to that which it would have at its equilibrium position in the next shell of the distribution. Some of the kinetic energy will be dissipated in this case due to induced surface currents, electron-hole generation, plasmons and phonon excitation. The numerical simulation shows that for as few as 300 particles in a self interacting hexagonal array, the incident nucleus or molecular ion of deuterium approaches with an energy of about 0.5 KeV, well into the range of energies where the fusion cross-section becomes significant. Extrapolation of the curve to higher particle number in the attracting array leads to the following scaling prediction as a function of the total number of particles, N:

U(eV)=5.6+1.25N (15)

This result shows that a distant nucleus or molecular ion on a surface can be attracted and collided with an energy of 10 KeV with a stabilized collection of image-bound surface nuclei with as little as 10,000 particles and which occupies of the order of 15 nm². Such small areas suggest that this type of process could occur in sufficiently smooth pores of dimensions in the 10 nm range.

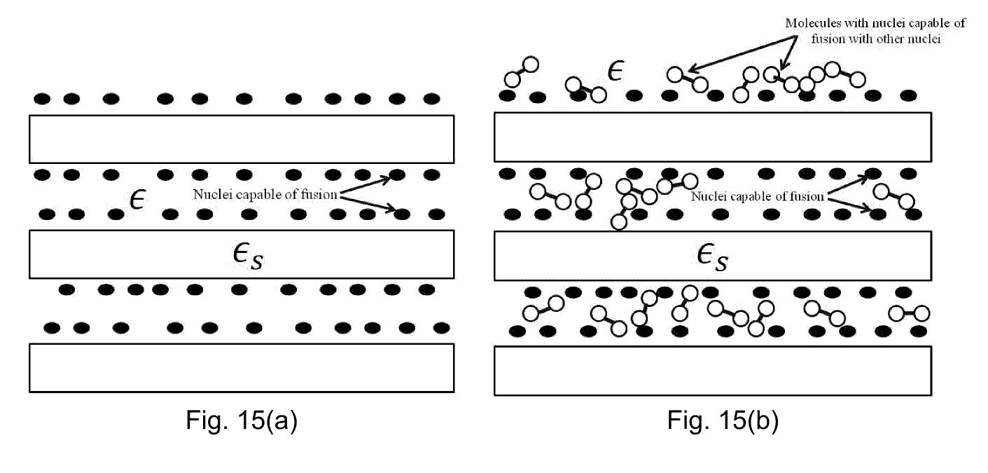

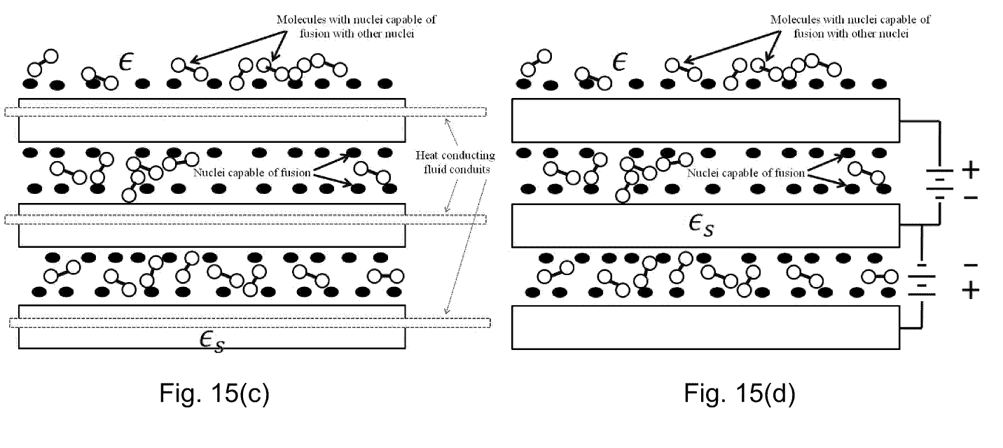

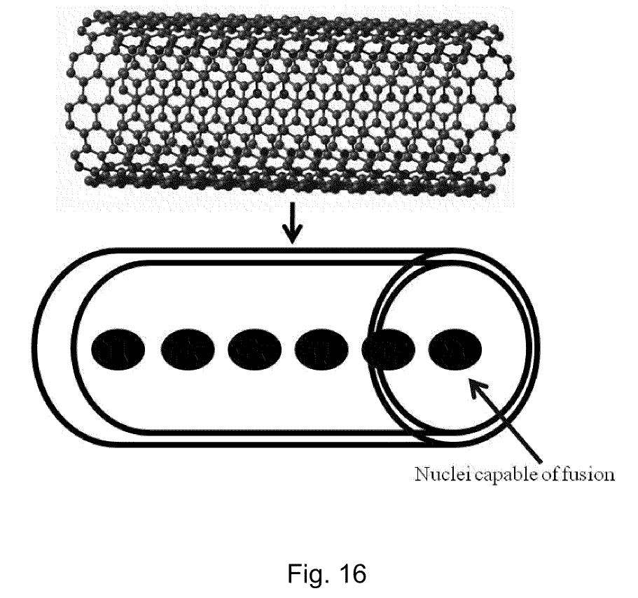

In an alternative embodiment, multiple surfaces may be implemented to enhance the generation of energy process. FIGS. 15(a)-(d) show the implementation of this embodiment with a series of substrates and fusion-capable nuclei disposed between the substrates. In addition to having multiple surfaces, the surface itself may have a variety of forms. In one embodiment, the surface is the interior of a pore within a porous medium of dielectric constant, ∈, in porous medium of dielectric constant, ∈_{S}. The surface may also be constructed to support plasmon-polariton resonances due to phonon or electronic response, and which results in large field enhancements at certain wavelengths. In yet another embodiment, the surface may be the interior or exterior of a tube, such as a single walled carbon nanotube as shown in FIG. 16, a multi-walled carbon nanotube, or an inclusion complex such as urea.

In a further embodiment, tubes or conduits extend through the substrates to carry fluid for the transport of generated heat within the substrate.

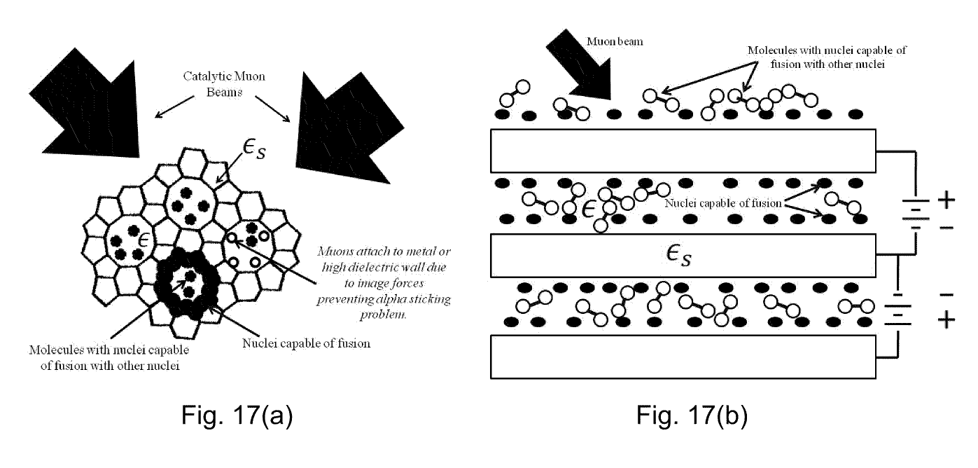

In order to arrange the structures described above, nuclei must be dissociated or ionized from their electrons through the application of energy. As described above, muon beams have been used as a catalyst to removing the electrons, however with limited results due to the alpha sticking problem. According to one embodiment, as shown in FIGS. 17(a)-(b), a muon beam is used with a structure as described above to catalyze fusion with surface image forces competing with the alpha particles for muons to prevent the alpha sticking problem and the termination of the catalysis.

Alternatively, application of an energy field or radiation may be applied by an electric field, as shown in FIG. 15(d), or light such as an infrared laser (CO₂ or N₂O) having a wavelength in the infrared range of about 2-15 microns, or photons with energies in the range of 20 eV to 1 eV. According to other embodiments of the invention, radiation such as microwave radiation, infrared radiation, visible light, ultra violet radiation, or X-Ray radiation may be used to create fusable nuclei or ions containing fusable nuclei on the dielectric surface.

While the embodiments of the invention described herein include the deposition of deuterium nuclei on a metal or other substrate having a substantially high dielectric constant such as SiC, a zeolite or inclusion compound or clathrate, one skilled in the art should recognize that the surface material may include other materials with a sufficiently high dielectric constant to achieve the β relationship described herein. Further, other light nuclei (e.g., H, T, Li, He, etc.) and like-charged particles, such as electrons, as well as atomic or molecular ions such as ionized deuterium molecules, may be utilized without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims Moreover, unless specifically stated any use of the terms first, second, etc. do not denote any order or importance, but rather the terms first, second, etc. are used to distinguish one element from another.

What is claimed is:

1. A method of generating a reaction comprising:
providing a surface formed between a first medium and a second medium, the first medium having a first dielectric constant, ∈, and the second medium having a second dielectric constant, ∈_{S}, wherein ∈ and ∈_{S} satisfy the relationship:
$$\frac{( ɛ - {ɛ}_{S} )}{( ɛ + {ɛ}_{S} )} < - \frac{1}{2} ;$$
depositing a plurality of like-charged particles capable of reaction in the first medium adjacent to the surface;
wherein a collective potential binding energy between the plurality of like-charged particles causes a distance between at least two of the like-charged particles to be sufficiently small to result in the reaction of at the least two like-charged particles.

2. The method of claim 1 wherein the like-charged particles are nuclei and the reaction is nuclear fusion.

3. The method of claim 2 wherein cooperative long-range effects of the plurality of like-charged particles cause the distance between the at least two like-charged particles to be sufficiently small to result in fusion.

4. The method of claim 2 further comprising attracting a distant nucleus to the plurality of like-charged particles with sufficient energy to cause a collision with one of the plurality of like-charged particles and to cause the fusion reaction.

5. The method of claim 2 further comprising forming the plurality of like-charged particles capable of fusion using radiation.

6. The method of claim 5 wherein the radiation is selected from the group consisting of microwave radiation, infrared radiation, visible light, ultraviolet radiation, and X-Ray radiation.

7. The method of claim 2 wherein the like-charged particles are selected from the group consisting of H, D, T, Li, and He.

8. The method of claim 1 wherein the like-charged particles are ions and the reaction is chemical.

9. The method of claim 8 wherein cooperative long-range effects of the plurality of like-charged particles cause the distance between the at least two like-charged particles to be sufficiently small to result in the chemical reaction.

10. The method of claim 8 further comprising attracting a distant ion to the plurality of like-charged particles with sufficient energy to cause a collision with one of the plurality of like-charged particles and to cause the chemical reaction.

11. The method of claim 8 further comprising forming the plurality of like-charged particles capable of chemical reaction using radiation.

12. The method of claim 11 wherein the radiation is selected from the group consisting of microwave radiation, infrared radiation, visible light, ultraviolet radiation, and X-Ray radiation.

13. The method of claim 1 wherein the plurality of like-charged particles capable of reaction are formed from an electrical discharge of atoms or molecules.

14. The method of claim 1 wherein the first medium comprises a conduit to carry fluid for transmitting heat generated within the first medium.

15. The method of claim 1 wherein the second medium comprises a conduit to carry fluid for transmitting heat generated within the second medium.

16. The method of claim 1 wherein the surface supports plasmon-polariton or phonon-polariton resonance due to a phonon or electronic response.

17. The method of claim 1 wherein the surface supports a localized plasmon-polariton or phonon-polariton resonance due to a phonon or electronic response.

18. The method of claim 1 wherein the second medium comprises SiC.

19. The method of claim 1 wherein the surface includes an interior of a pore within a porous medium, the pore being the first medium and the porous medium comprising the second medium.

20. The method of claim 19 wherein the porous medium comprises a conduit to carry fluid for transmitting heat generated within the porous medium.

21. The method of claim 19 wherein the porous medium supports plasmon-polariton resonance.

22. The method of claim 19 wherein the porous medium is selected from the group consisting of SiC, a zeolite, an inclusion compound, and a clathrate.

23. The method of claim 19 wherein the porous medium is substantially transparent to radiation capable of dissociating molecules containing like-charged particles capable of fusion.

24. The method of claim 1 further comprising applying a muon beam to catalyze fusion.

25. The method of claim 1 wherein the second medium is a catalyst material with an affinity for electrons.

26. The method of claim 1 wherein the surface is the exterior of a tube.

27. The method of claim 1 wherein the surface is the interior of a tube.

28. The method of claim 27 wherein the tube is a carbon nanotube.

29. The method of claim 27 wherein the tube is an inclusion complex.

30. The method of claim 29 wherein the inclusion complex comprises an adduct.

31. The method of claim 28 wherein the nanotube is a multi-walled carbon nanotube.

32. The method of claim 1 wherein the like-charged particles comprise electrons.

33. A method of generating a fusion reaction comprising:
providing a surface formed between a first medium and a second medium, the first medium having a first dielectric constant, ∈, and the second medium having a second dielectric constant, ∈_{S}, wherein ∈ and ∈_{S} satisfy the relationship:
$$\frac{( ɛ - {ɛ}_{S} )}{( ɛ + {ɛ}_{S} )} < - \frac{1}{2} ;$$
depositing a plurality of ions with nuclei capable of fusion in the first medium adjacent to the surface;
wherein a potential binding energy between the plurality of ions causes a distance between at least two of the ions to be sufficiently small to result in fusion of the at least two ions.

34. The method of claim 33 wherein the ions are atomic ions or molecular ions.

35. The method of claim 33 wherein the plurality of ions contain nuclei selected from the group consisting of H, D, T, Li and He.

36. A method of generating a fusion reaction comprising:
providing an array of surfaces formed by alternating first mediums and second mediums, the first mediums having a first dielectric constant, ∈, and the second mediums having a second dielectric constant, ∈_{S}, wherein ∈ and ∈_{S} satisfy the relationship:
$$\frac{( ɛ - {ɛ}_{S} )}{( ɛ + {ɛ}_{S} )} < - \frac{1}{2} ;$$
depositing a plurality of like-charged particles capable of reaction in the first mediums adjacent to the surfaces;
wherein a potential binding energy between the plurality of like-charged particles causes a distance between at least two of the like-charged particles to be sufficiently small to result in reaction of the at least two like-charged particles.

37. The method of claim 36 wherein the like-charged particles are nuclei and the reaction is nuclear fusion.

38. The method of claim 36 wherein the like-charged particles are ions and the reaction is chemical.

39. The method of claim 36 wherein the array of surfaces is formed by an intercalated compound selected from the group consisting of cuprates, graphite and grapheme.

40. The method of claim 36 further comprising applying an electric field between the array surface layers.

41. The method of claim 36 further comprising applying a muon beam to catalyze nuclear fusion.

42. The method of claim 36 wherein the array of surfaces is radiated with light to dissociate and ionize the plurality of like-charged particles.

43. The method of claim 42 wherein the light has a dissociation wavelength in the infrared range from 2-15 microns.

44. The method of claim 42 wherein the radiated light is produced using a CO₂ or N₂O laser.

45. The method of claim 42 wherein the radiated light comprises photons with energies in the range from 20 eV to 1 eV.

46. The method of claim 36 wherein the like-charged particles are electrons and the binding of the electrons results in bosonic properties.
